(19) United States
(12) Patent Application Publication
(10) Pub. No.: US 2018/0017028 A1
(43) Pub. Date: Jan. 18, 2018

(54) DUAL IN-TANK FUEL PICK-UP SYSTEM

(71) Applicant: Ford Global Technologies, LLC, Dearborn, MI (US)

(72) Inventors: Arthur Kalyuta, Southfield, MI (US); Arman Ashrafi, Dearborn Heights, MI (US); Edward Anthony Bertouille, Dearborn, MI (US); William Chernick, Carleton, MI (US)

(21) Appl. No.: 15/210,733

(22) Filed: Jul. 14, 2016

(51) Int. Cl. F02M 37/02; F04F 5/10; F02M 37/10; F04F 5/46; F02M 37/00

(52) U.S. Cl. CPC F02M 37/025; F04F 5/46; F02M 37/0082; F02M 37/10; F04F 5/10

(57) ABSTRACT

Methods and systems are provided for a dual in-tank fuel pick-up system. The dual pick-up system includes a fuel delivery module (FDM) with a fuel pump and a jet pump. Fuel is made available to the FDM through one or more fuel pick-ups bringing in fuel from different locations of a fuel tank to a reservoir of the FDM from where the fuel is pumped by the fuel pump to a coupled engine system.

### FIELD

The present description relates generally to methods and systems for a fuel delivery system of a vehicle.

### BACKGROUND/SUMMARY

A fuel delivery system of a vehicle may include a fuel tank coupled to a fuel pump to supply high-pressure fuel from the fuel tank to engine cylinders for combustion. The fuel pump draws fuel from a fuel pick-up location inside the fuel tank and pumps it outside the fuel tank though a supply line coupled to the engine cylinders. Respective fuel levels in different sections of the fuel tank may vary at a given time, such as when the vehicle is driving on a gradient. In conditions where fuel in the fuel tank is accumulated in one section of the fuel tank, for example, when the fuel tank has low fuel levels and/or the vehicle is operating on a gradient, fuel may not be available at the fuel pick-up location inside the fuel tank. In absence of fuel in the fuel pick-up location, fuel supply to the fuel pump may be interrupted, disrupting vehicle operation.

One approach for maintaining fuel supply to the fuel pump during vehicle operation includes multiple fuel pick-up lines coupled to the fuel pump. The multiple fuel pick-up lines may supply fuel from different fuel pick-up locations inside the fuel tank to the fuel pump.

However, the inventors herein have recognized potential issues with such systems. As one example, when no fuel is present at a given fuel pick-up location inside the fuel tank, air may be introduced into the fuel pump through that fuel pick-up line, which may aerate the fuel being supplied through the fuel pump and damage the fuel pump. In one approach, check valves may be installed at an end of the fuel pick-up line to prevent aeration of the fuel, which may increase the cost and the complexity of the fuel delivery system.

In one example, the issues described above may be addressed by a fuel delivery module, including a fuel pump, a jet pump, a reservoir housing the fuel pump and the jet pump, at least one fuel pick-up configured to fluidically connect a fuel pick-up location of a fuel tank to the jet pump, the jet pump drawing fuel from the fuel pick-up location into the reservoir, and an internal fuel pick-up inside the reservoir configured to fluidically connect the reservoir to the fuel pump.

One example method of operating the above-described fuel delivery module includes drawing fuel from a fuel pick-up location of the fuel tank through a fuel pick-up line coupled to the jet pump, and directing fuel from the jet pump to the reservoir, the reservoir supplying fuel to the fuel pump for delivering fuel to an engine. Fuel supply to the fuel pump may be only through the fuel collected in the reservoir through an internal fuel pick-up inside the reservoir and not directly from the fuel tank. Hence, change in fuel levels/fuel availability at the fuel pick-up location of the fuel tank may not immediately alter the availability of fuel to the fuel pump.

In this way, fuel collected inside the reservoir of the FDM by the jet pump is supplied to the fuel pump even when no fuel is available at the fuel pick-up location of the fuel tank, maintaining uninterrupted fuel supply to the engine during vehicle operation and preventing introduction of air into the fuel pump.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a fuel delivery system of a vehicle engine.

FIG. 2 shows a cross-section of a fuel tank with a fuel delivery module

FIG. 3 illustrates a cross-section of the fuel delivery module of FIG. 2.

FIG. 4 is a schematic illustrating the fuel deliver module of FIG. 3.

FIGS. 5A, 5B, and 5C illustrate schematics of a fuel supply to a fuel pump inside a fuel tank that is positioned along different gradients.

FIG. 6 shows a method of supplying fuel to a fuel pump inside a fuel tank.

### DETAILED DESCRIPTION

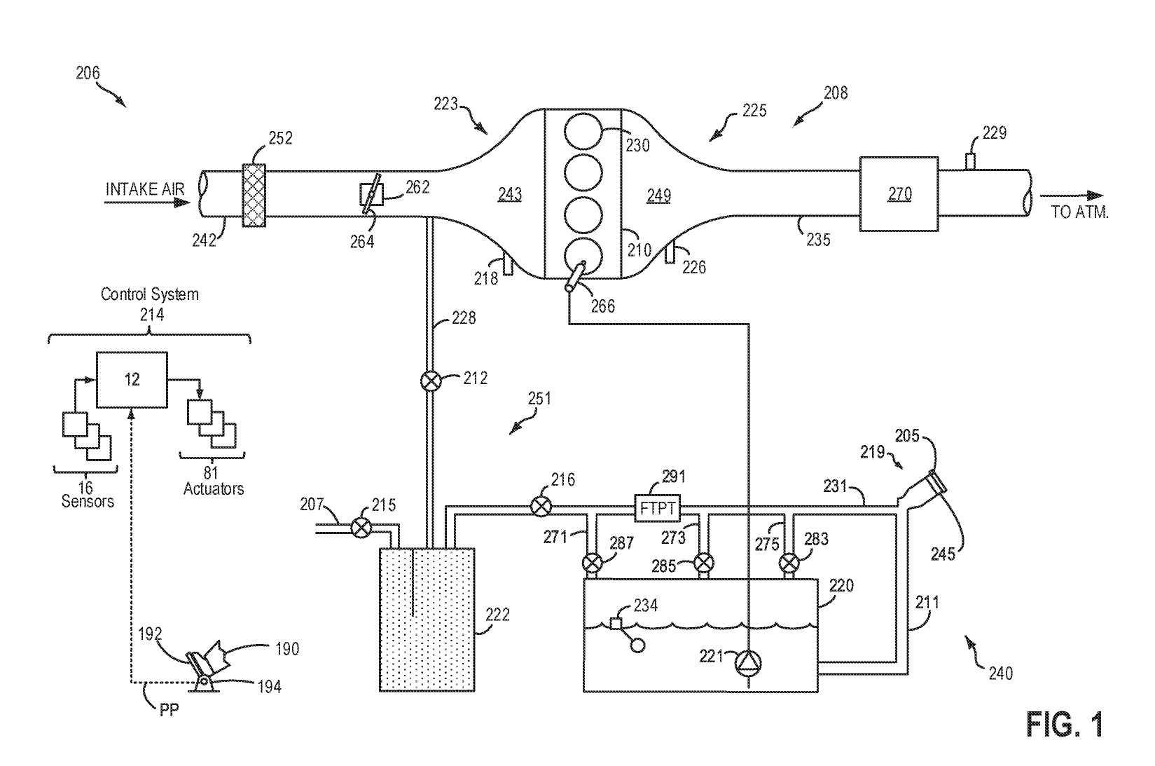

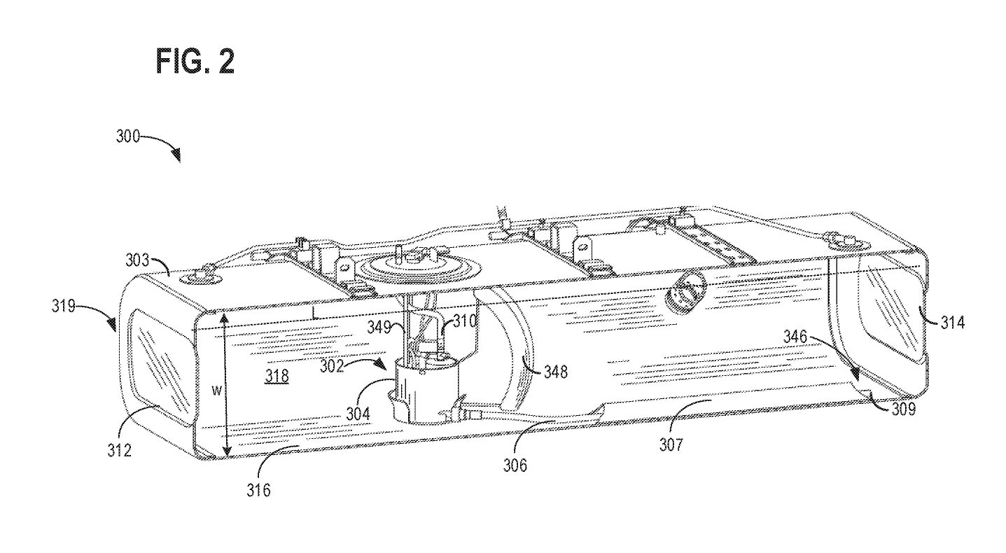

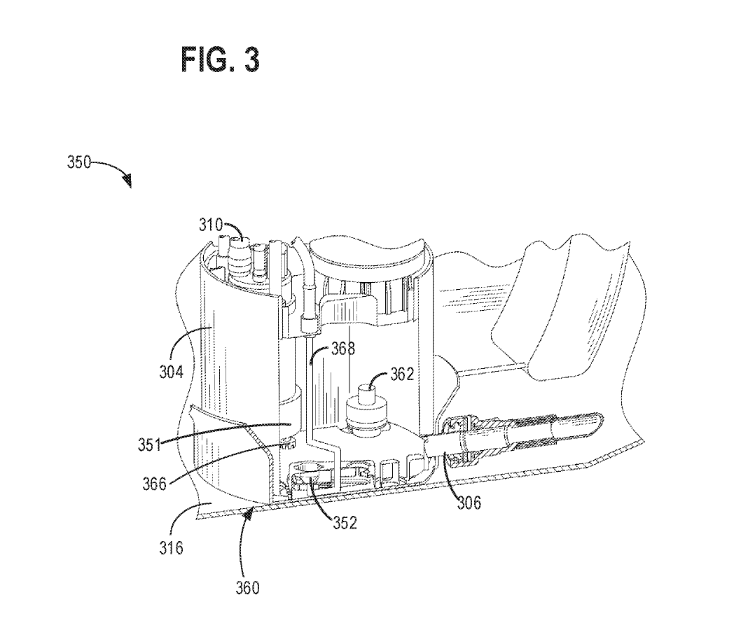

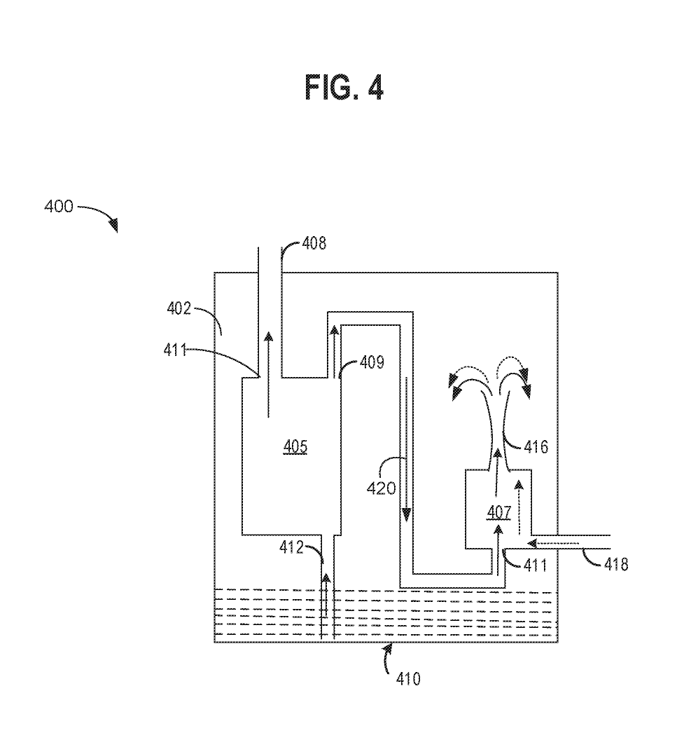

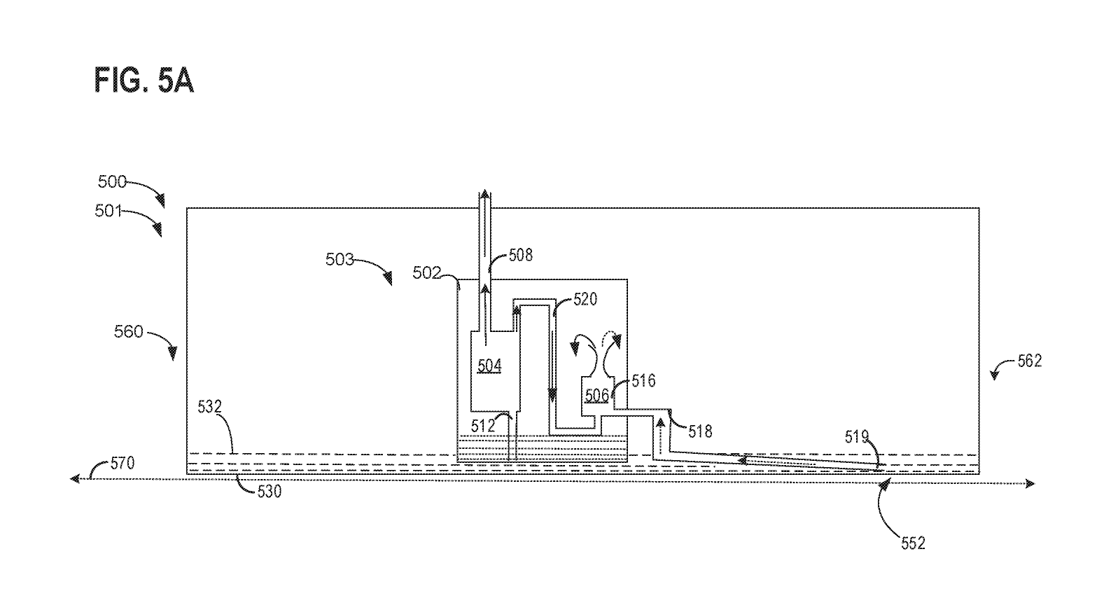

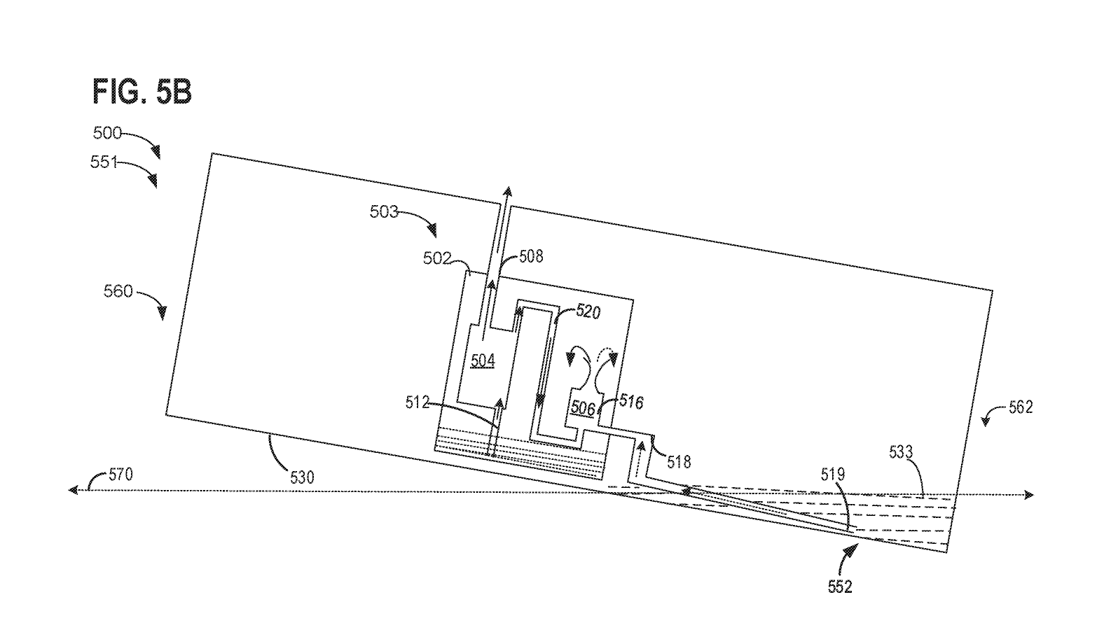

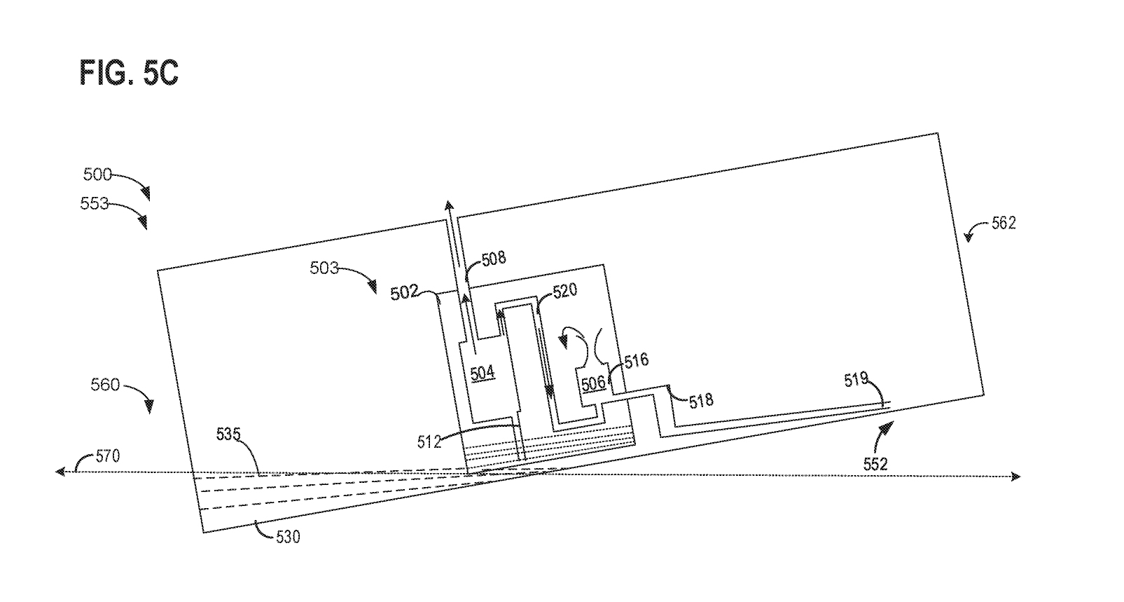

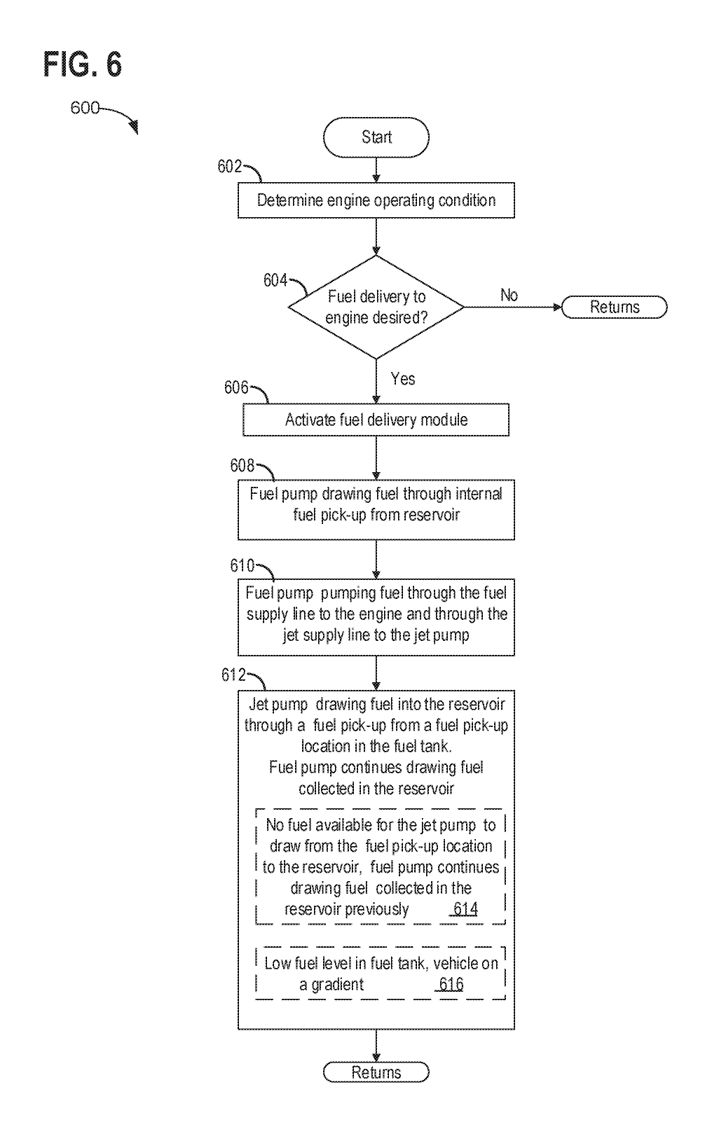

The following description relates to systems and methods for delivering fuel from a fuel tank of a vehicle to an engine system of the vehicle, such as the engine system illustrated in FIG. 1. The fuel tank may include a fuel delivery module (FDM), the FDM receiving fuel from through a fuel pick-up, as illustrated in FIGS. 2 and 3. FIGS. 2 and 3 are drawn approximately to scale although various modifications in the relative sizing of one or more components may be made. The supply of fuel to the FDM from a fuel pick-up location is illustrated in a schematic in FIG. 4. The availability of fuel to the fuel pump for supplying to the engine even when low fuel levels are present inside the fuel tank may prevent the introduction of air into the fuel pump. The schematics in FIGS. 5A-5C illustrate fuel delivery to the fuel pump when the vehicle is operating along various gradients. An example method, as shown in FIG. 6, illustrates operation of the FDM to maintain uninterrupted fuel supply to the fuel pump of the fuel delivery module.

In one embodiment, a FDM inside a fuel tank may include a jet pump drawing fuel into a reservoir of the FDM from at least one fuel pick-up location. A fuel pump of the FDM may draw fuel from the reservoir, and not directly from the fuel tank. Hence, if no fuel is present at the at least one fuel pick-up location, fuel may be still supplied from the reservoir to the fuel pump, without introducing air into the fuel pump. No check valves may be required along the fuel pick-up line to prevent the introduction of air into the fuel pump as an internal fuel pick up of the FDM may fluidically connect the reservoir to the fuel pump. The FDM without check valves along one or more fuel pick-up lines may be a more cost-effective fuel delivery system compared to a fuel delivery system using check valves for preventing aeration of the fuel pump.

FIGS. 1-5C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

FIG. 1 shows a schematic depiction of a vehicle system 206. The vehicle system 206 includes an engine system 208 coupled to an emissions control system 251 (also termed an evaporative emissions system) and a fuel system 240. The emission control system 251 includes a fuel vapor canister 222, which may be used to capture and store fuel vapors. In some examples, the vehicle system 206 may be a hybrid electric vehicle system.

The engine system 208 may include an engine 210 having a plurality of cylinders 230. The engine 210 may be controlled at least partially by a control system 214 including a controller 12 and by input from a vehicle operator 190 via an input device 192. In one example, the input device 192 may include an accelerator pedal and a pedal position sensor 194 for generating a proportional pedal position signal PP.

The engine 210 may include an engine intake 223 and an engine exhaust 225. The engine intake 223 includes a throttle 262 coupled to an intake manifold 243. Fresh intake air enters an intake passage 242 and flows through an air filter 252 before streaming past the throttle 262 into the intake manifold 243. The throttle 262 includes a throttle plate 264. In the depicted example a position of the throttle 262 (specifically, a position of the throttle plate 264) may be varied by the controller 12 of a control system 214 via a signal provided to an electric motor or actuator included with the throttle 262, a configuration that is commonly referred to as electronic throttle control (ETC). In this manner, the throttle 262 may be operated to vary an amount of intake air provided to the intake manifold 243 and the plurality of cylinders therein.

The engine exhaust 225 includes an exhaust manifold 249 leading to an exhaust passage 235 that routes exhaust gas to the atmosphere. The engine exhaust 225 may include one or more emission control devices 270, which may be mounted in a close-coupled position in the exhaust. One or more emission control devices may include a three-way catalyst, lean NOx trap, diesel particulate filter, oxidation catalyst, etc. It will be appreciated that other components may be included in the engine such as a variety of valves and sensors.

A fuel system 240 may include a fuel tank 220 coupled to a fuel delivery module. The fuel delivery module may include a fuel pump 221. The fuel pump 221 is depicted situated within the fuel tank 220 and supplying fuel to a fuel injector 266 of the engine 210. Further, the fuel pump 221 may be a variable speed pump wherein the speed of the fuel pump can be modulated via the controller 12 based on different conditions. Alternatively, the fuel pump 221 may be capable of operation at a single speed. As such, the fuel pump 221 may be at least partially submerged or surrounded by fuel in the fuel tank 220. In one example, the fuel tank 220 may include a liquid fuel such as gasoline. In another example, the liquid fuel in fuel tank 220 may be gasoline and ethanol (e.g., E10, E85, etc.).

The fuel system 240 may include additional fuel pumps for pressurizing fuel delivered to the fuel injectors of engine 210. While only a single fuel injector 266 is shown in FIG. 1, additional injectors are provided for each of the plurality of cylinders 230. It will be appreciated that the fuel system 240 may be a return-less fuel system, a return fuel system, or various other types of fuel system. A fuel level sensor 234 located in fuel tank 220 may provide an indication of the fuel level (“Fuel Level Input” or FLI) to the controller 12. As depicted, the fuel level sensor 234 may comprise a float connected to a variable resistor. Alternatively, other types of fuel level sensors may be used.

Vapors generated in the fuel system 240 may be routed to the evaporative emission control system 251, specifically to the fuel vapor canister 222 via a vapor recovery line 231, before being purged to the engine intake 223.

The vapor recovery line 231 may be coupled to the fuel tank 220 via one or more conduits and may include one or more valves for isolating the fuel tank during certain conditions. For example, the vapor recovery line 231 may be coupled to the fuel tank 220 via one or more or a combination of conduits 271, 273, and 275. Further, in some examples, one or more fuel tank vent valves may be included in the conduits 271, 273, or 275. Among other functions, the fuel tank vent valves may allow a fuel vapor canister of the emissions control system to be maintained at a low pressure or vacuum without increasing the fuel evaporation rate from the tank (which would otherwise occur if the fuel tank pressure were lowered). For example, the conduit 271 may include a grade vent valve (GVV) 287, the conduit 273 may include a fill limit-venting valve (FLVV) 285, and the conduit 275 may include a grade vent valve (GVV) 283.

Further, in some examples, the vapor recovery line 231 may be coupled to a refueling system 219. In some examples, the refueling system 219 may include a fuel cap 205 for sealing off the refueling system from the atmosphere. The refueling system 219 may be coupled to the fuel tank 220 via a fuel filler pipe 211.

Further, the refueling system 219 may include a refueling lock 245. In some embodiments, the refueling lock 245 may be a fuel cap locking mechanism. The fuel cap locking mechanism may be configured to automatically lock the fuel cap in a closed position. For example, the fuel cap 205 may remain locked via the refueling lock 245 while pressure or vacuum in the fuel tank is greater than a threshold. In response to a refuel request, e.g., a vehicle operator initiated request, the fuel tank may be depressurized, and the fuel cap may be unlocked after the pressure or vacuum in the fuel tank falls below a threshold. A fuel cap locking mechanism may be a latch or clutch, which, when engaged, prevents the removal of the fuel cap. The latch or clutch may be electrically locked, for example, by a solenoid, or may be mechanically locked, for example, by a pressure diaphragm.

In some embodiments, the refueling lock 245 may be a filler pipe valve located at a mouth of fuel filler pipe 211. In such embodiments, the refueling lock 245 may not prevent the removal of the fuel cap 205. Rather, the refueling lock 245 may prevent the insertion of a refueling pump into fuel filler pipe 211. The filler pipe valve may be electrically locked, for example by a solenoid, or mechanically locked, for example by a pressure diaphragm.

In some embodiments, the refueling lock 245 may be a refueling door lock, such as a latch or a clutch, which locks a refueling door located in a body panel of the vehicle. The refueling door lock may be electrically locked, for example by a solenoid, or mechanically locked, for example by a pressure diaphragm.

In embodiments where refueling lock 245 is locked using an electrical mechanism, the refueling lock 245 may be unlocked by commands from controller 12, for example, when a fuel tank pressure decreases below a pressure threshold. In embodiments where refueling lock 245 is locked using a mechanical mechanism, the refueling lock 245 may be unlocked via a pressure gradient, for example, when a fuel tank pressure decreases to atmospheric pressure.

The fuel vapor canister 222 in evaporative emissions control system 251 may be filled with an appropriate adsorbent to temporarily trap fuel vapors (including vaporized hydrocarbons). Fuel vapor canisters in hybrid vehicles may receive refueling vapors generated during fuel tank refilling operation as well as diurnal vapors generated during daily changes in ambient temperature. In one example, the adsorbent used is activated charcoal. While a single fuel vapor canister 222 is shown, it will be appreciated that emissions control system 251 may include any number of canisters.

When purging conditions are met, such as when the canister is saturated, vapors stored in the fuel vapor canister 222 may be purged to the engine intake 223, specifically the intake manifold 243, via the purge line 228 by opening a canister purge valve 212. Fresh air may be drawn through the vent line 207 via a canister vent valve 215 into fuel vapor canister 222 to enable desorption of stored fuel vapors from the evaporative emission control system 251. For example, the canister vent valve 215 may be a normally open valve, which may be maintained open to draw fresh air into the fuel vapor canister 222 via the vent line 207. The canister purge valve 212 may be normally closed but may be opened during certain conditions so that vacuum from the engine intake manifold 243 is provided to the fuel vapor canister for purging desorbed fuel vapors.

Flow of air between the fuel vapor canister 222 and atmosphere may be regulated by the canister vent valve 215. A fuel tank isolation valve 216 (FTIV 216) may control venting of vapors from the fuel tank 220 into the fuel vapor canister 222 (and air into atmosphere). FTIV 216 may be positioned between the fuel tank and the fuel vapor canister within the vapor recovery line 231. FTIV 216 may be a normally closed valve that when opened allows for the venting of fuel vapors from the fuel tank 220 to the fuel vapor canister 222. Air stripped of fuel vapors may then be vented from the fuel vapor canister 222 to atmosphere via the canister vent valve 215 and the vent line 207. Fuel vapors stored in the fuel vapor canister 222 may be purged to the engine intake 223 via the canister purge valve 212 later.

Controller 12 may comprise a portion of a control system 214. Control system 214 is shown receiving information from a plurality of sensors 16 (various examples of which are described herein) and sending control signals to a plurality of actuators 81 (various examples of which are described herein). As one example, sensors 16 may include fuel level sensor 234, exhaust gas sensor 226 located upstream of the emission control device 270, manifold absolute pressure (MAP) sensor 218, post-catalyst exhaust sensor 229, and fuel tank pressure sensor 291 (also termed a fuel tank pressure transducer or FTPT). Other sensors such as barometric pressure, ambient temperature, air/fuel ratio, and composition sensors may be coupled to various locations in the vehicle system 206. For example, a temperature of fuel in the fuel tank may be monitored via a fuel tank temperature sensor (not shown). As another example, the actuators 81 may include the fuel injector 266, the throttle 262, the fuel tank isolation valve 216, the fuel pump 221, the purge valve 212, and the refueling lock 245. The controller 12 may receive input data from the various sensors, process the input data, and trigger the actuators in response to the processed input data based on instruction or code programmed therein corresponding to one or more routines.

One embodiment of the fuel tank 220 may include the fuel tank 220 housing the fuel delivery module, which may include one or more fuel pick-ups, each fuel pick-up drawing in fuel from a different fuel pick-up location within the fuel tank to the fuel delivery module. The fuel delivery module may be located at a central location inside the fuel tank or may be located at other locations, which are not in the center of the fuel tank. Irrespective of the location of the fuel delivery module inside the fuel tank, fuel may be delivered to the fuel pump of the fuel delivery module from one or more fuel pick-up locations within the fuel tank.

As fuel levels inside the fuel tank change (for example, reduced fuel level due to fuel consumption after driving or fuel tank filled to capacity during a refueling event), the availability of fuel in different fuel pick-up locations inside the fuel tank may vary also. In one example, when fuel left inside the fuel tank is very low (for example, less than 4% of the fuel tank is full), and the vehicle is operating on a gradient, the fuel may accumulate only at one location inside the fuel tank and not at other locations inside the fuel tank. In such a scenario, no fuel may be available in one or more fuel pick-up locations, and in absence of check valve along the fuel pick-up lines, air may be introduced into the fuel pump. Therefore, the location of the one or more fuel pick-ups within the fuel tank may be configured to ensure supply of fuel to a reservoir of the fuel delivery module. Fuel in the reservoir may be available to the fuel pump even when low volume of fuel is present inside the fuel tank and the vehicle is navigating a gradient.

FIG. 2 shows a cross section of a fuel tank 300. The fuel tank 300 includes a fuel delivery module (FDM) 302 inside a fuel chamber 318 of the fuel tank 300. A fuel supply line 310 fluidically connects the fuel delivery module 302 to outside of the fuel tank, to an engine (for example, the engine 210 of FIG. 1). The fuel tank 300 may be one non-limiting example of fuel tank 220 of the vehicle system 206 illustrated in FIG. 1.

The fuel tank 300 may include a top wall 303 and a bottom floor 316, opposite the top wall 303. The fuel tank 300 also includes a first wall 312 and a second wall 314, opposite the first wall 312 and parallel to the first wall 312 of the fuel tank 300. A first sidewall 319 and a second sidewall (not shown) opposite the first sidewall 319 and parallel to the first sidewall 319 may be present along a length L of the fuel tank. The first wall 312 and the second wall 314 along with the top wall 303 and the bottom floor 316 and the first sidewall 319 and the second sidewall may define the fuel chamber 318, as illustrated in FIG. 2.

The top wall 303 and the bottom floor 316 may be separated by a width W along the length L of the fuel tank 300. The width W may be uniform throughout the length of the fuel tank 300 or may vary along the length L of the fuel tank.

The fuel tank 300 may be positioned in a vehicle such that the first wall 312 may be oriented to be closer to a front end of the vehicle and the second wall 314 may be closer to a rear end of the vehicle. Additionally, the top wall 303 may be closer to a roof of the vehicle and farther from an underbody of the vehicle. The bottom floor 316 of the fuel tank may be closer to the underbody of the vehicle and farther from the roof of the vehicle. The length L of the fuel tank 300 may be parallel to a longitudinal axis of the vehicle (the longitudinal axis of the vehicle running from the front end to the rear end of the vehicle, not shown). In other examples, alternative configuration and placement of the fuel tank in the vehicle may be possible.

In one example, the fuel tank may be a planar fuel tank, where the bottom floor 316 may not be divided into multiple fluidically connected chambers. Instead, the fuel tank may include one chamber, such as the fuel chamber 318. In another example, the fuel tank may be divided into fluidically connected chambers (two or more chambers), for example, a saddle fuel tank with two fluidically connected chambers.

Inside the fuel chamber 318, the FDM 302 may be present closer to the first wall 312 and farther from the second wall 314, as illustrated in FIG. 2. In another example, the FDM 302 may be present in a center of the fuel chamber, equidistant from the first wall and the second wall. In yet another example, the FDM may be closer to the second wall 314 and farther from the first wall 312.

The FDM 302 may include a fuel pick-up 306. The fuel pick-up 306 may fluidically connect a fuel pick-up location 346 of the fuel tank to the FDM 302. In one example, the fuel pick-up location 346 may be closer to the second wall 314 of the fuel chamber, as illustrated in FIG. 2. In some examples, more than one fuel pick-up may fluidically connect additional fuel pick-up locations inside the fuel tank to the FDM.

The fuel pick-up 306 may be anchored to the bottom floor 316 by at least one retaining clasp 307. The fuel pick-up may have a pick-up inlet 309 fluidically connecting the fuel pick-up location 346 to the FDM 302. The pick-up inlet 309 may be positioned such that the pick-up inlet is close to the bottom floor 316, wherein even when a very low level of fuel is present in the fuel pick-up location 346, the pick-up inlet may be at least partially submerged in the fuel.

A fuel level sensor 348 may be present inside the fuel chamber 318. The fuel level sensor may be configured to be close to the bottom floor of the fuel tank to sense fuel levels accurately. The fuel level sensor may be attached to the FDM and may provide sensed fuel level input to a controller, for example, to the controller 12 of FIG. 1. In other examples, additional fuel level sensors may be present in different locations inside the fuel tank.

The FDM may be anchored to the fuel chamber, for example, by anchoring lines 349 connecting to the top wall 303, which may prevent the FDM from moving to different locations inside the fuel chamber.

The FDM 302 may include a reservoir 304. A cross section 350 of the reservoir 304 of the FDM 302 is shown in FIG. 3. The features of the FDM 302 illustrated in FIG. 3 are described in relation to FIG. 2. Components previously introduced in FIG. 2 are numbered similarly and not reintroduced. The reservoir 304 may be a hollow chamber with a fuel pump 351 and a jet pump 352. A base 360 of the reservoir 304 may be positioned along the bottom floor 316 of the fuel chamber 318 shown in FIG. 2.

The fuel pick-up 306 may fluidically connect to the jet pump 352 inside the reservoir, drawing fuel from the fuel pick-up location 346 (illustrated in FIG. 2) to the jet pump 352. Fuel from the jet pump 352 may be drawn through a venturi passage 362 to be collected inside the reservoir 304. Fuel collected inside the reservoir 304 may be available to the fuel pump 351 through an internal fuel pick-up 366 that may be at least partially submerged in the fuel inside the reservoir 304. The internal fuel pick-up 366 may direct fuel from reservoir 304 to the fuel pump.

A connecting line 368 from the fuel pump to the jet pump may supply fuel to the jet pump for operating the jet pump. High-pressure fuel from the fuel pump may be delivered through the supply line 310 to the engine and some of the high-pressure fuel from the fuel pump may be directed through the connecting line 368 to a motive inlet of the jet pump 352. The high-pressure fuel delivered to the jet pump 352 along with the fuel delivered through the fuel pick-up 306 to the jet pump flows through the venturi passage 362 and accumulates inside the reservoir 304.

The jet pump 352 may directly draw fuel from the bottom floor 316 through the fuel pick-up 306 and the fuel pump may draw fuel through the internal fuel pick-up submerged in the fuel collected inside the reservoir. The fuel pump may not draw fuel directly from the fuel tank. Instead, the fuel pump may always pump fuel collected in the reservoir whenever there is a demand for fuel supply to the engine. In other examples, the jet pump may be drawing fuel into the reservoir through additional fuel pick-ups.

In one embodiment, the fuel tank may be a saddle fuel tank with a first fuel chamber fluidically connected to a second fuel chamber. In one example, the FDM may be in the first fuel chamber. The jet pump may draw fuel to the FDM through the fuel pick-up from the fuel pick-up location in the second fuel chamber and deposit the fuel in the reservoir of the FDM. An additional fuel pick-up present in the first chamber may supply fuel to the reservoir of the FDM. The fuel pump of the FDM may deliver the fuel from the reservoir through the supply line to the engine.

FIG. 4 shows a schematic of a fuel delivery module (FDM) 400 including a reservoir 402. The schematic of the FDM 400 may represent the FDM 302 inside the fuel tank 300 of FIG. 2. The reservoir 402 may house a fuel pump 405 and a jet pump 407. A base 410 of the reservoir may be may be placed on the bottom floor of a fuel tank (for example, the bottom floor 316 of the fuel tank 300 illustrated in FIG. 1).

The fuel pump 405 may receive fuel through an internal fuel pick-up 412 delivering fuel from the reservoir 402 to the fuel pump 405. The fuel pump 405 includes a first outlet 411, delivering fuel from the fuel pump 405 to a fuel supply line 408 fluidically coupling the FDM 400 to an engine. A second fuel outlet 409 of the fuel pump 405 may deliver fuel from the fuel pump to the jet pump 407 through a jet pump fuel supply line 420. In some examples, the fuel pump may include only one outlet coupled to a bifurcated fuel supply line that supplies fuel to an engine supply line and to a jet pump supply line. The fuel delivered from the fuel pump 405 to the jet pump 407 through a motive inlet 411 may be used for operating the jet pump. The jet pump 407 draws fuel through a fuel pick-up 418 fluidically connected to a fuel pick-up location inside the fuel tank, for example, the fuel pick-up 306 illustrated in FIGS. 2 and 3. The fuel being drawn along the y fuel pick-up line is indicated by dashed lines with arrowheads.

Fuel received in the jet pump 407 from the fuel pump 405 is high-pressure fuel (e.g., at a higher pressure than fuel in the reservoir or the fuel tank). The high-pressure fuel along with the additional fuel brought in by the fuel pick-up 418 to the jet pump 407 flows through a venturi 416 of the jet pump 407. The fuel flows through the venturi 416 and accumulates in the reservoir. The fuel collected in the reservoir 402 may be supplied to the fuel pump through the internal fuel pick-up 412. When no fuel is being drawn to the jet pump 407 through the fuel pick-up 418, fuel from the fuel pump being delivered to the jet pump flows through the venturi 416 into the reservoir 402.

In this way, the fuel pump 405 may receive fuel only through the internal fuel pick-up 412 coupled to the reservoir and not directly from the fuel tank. The fuel in the reservoir may be received from a fuel pick-up location of the fuel tank that is fluidically connected through the fuel pick-up 418 to the jet pump of the FDM 400.

FIGS. 5A, 5B, and 5C illustrate schematics of a fuel tank 500 housing a FDM 503 (similar to the fuel tank 300 with the FDM 302 and the FDM 400 schematic illustrated in FIGS. 2-4). The fuel tank 500 may be in a vehicle, fluidically connected to an engine of the vehicle (not shown). The schematics show the fuel tank 500 of the vehicle while the vehicle is operating on a flat surface (FIG. 5A), where a front end 560 of the vehicle and a rear end 562 of the vehicle are each along a horizontal plane 570. FIGS. 5B and 5C show the fuel tank 500 when the vehicle is on a gradient, for example, the vehicle is going uphill or downhill, wherein the front end of the vehicle is vertically higher or lower than the rear end of the vehicle. Additionally, fuel level 532 in the fuel tank may be low (for example, the fuel tank is only 5% full).

Referring to FIG. 5A, a schematic 501 shows the fuel tank 500 when the vehicle is operating along a flat surface and not a gradient (e.g., the front end and the rear end of the vehicle are along the same horizontal plane 570). Fuel inside the fuel tank is present along a bottom floor 530 of the fuel tank up to the fuel level 532, which indicates a low fuel level (for example, 5% of fuel capacity of the fuel tank). A fuel pick-up location 552 may be closer to the rear end 562 of the vehicle and farther from the front end of the vehicle 560.

As the vehicle is not navigating a gradient and is operating along a flat surface, the fuel level 532 is uniform along the bottom floor 530. During vehicle operation, the jet pump is drawing fuel from the fuel pick-up location 552 through the fuel pick-up 518. Fuel from the jet pump is directed to the reservoir 502. An internal fuel pick-up 512 of the fuel pump is submerged into the reservoir, supplying fuel from the reservoir to the fuel pump 504. The fuel from the fuel pump may be pumped through the supply line 508 to outside of the fuel tank, for example, to the engine of the vehicle. Additionally, fuel from the fuel pump may also be directed to the jet pump 506, for operating the jet pump

FIG. 5B shows a schematic 551 of the fuel tank 500 while the vehicle is navigating a gradient, for example, going uphill wherein the front end 560 of the vehicle is vertically higher than the rear end of the vehicle 562, relative to the horizontal plane 570. Due to the gradient, all fuel in the fuel tank accumulates along the fuel pick-up location 552 in the fuel tank, the fuel level indicated by 533, while no fuel is present towards the front end 560 of the fuel tank.

Fuel may be drawn into the jet pump through the fuel pick-up 518, wherein an inlet of the fuel pick-up may be submerged in fuel along the fuel pick-up location 552 of the fuel tank. The jet pump may be directing received fuel from the jet pump to the reservoir. The internal fuel pick-up 512 may be supplying fuel from the reservoir to the fuel pump for being pumped through the supply line 508. A portion of the fuel from the fuel pump may be directed to the jet pump for operating the jet pump and any residual fuel from the jet pump, along with the fuel drawn in through the fuel pick-up, may be collected inside the reservoir.

FIG. 5C shows a schematic 553 of the fuel tank 500 while the vehicle is navigating a gradient, for example, going downhill where the front end 560 of the vehicle is vertically lower than the rear end of the vehicle relative to the horizontal plane 570. Due to the gradient, all fuel in the fuel tank accumulates towards the front end 560 of the fuel tank, the fuel level indicated by 535, while no fuel is present along the fuel pick-up location 552 of the fuel tank.

As no fuel is available in the fuel pick-up location 552, no fuel is drawn by the jet pump into the reservoir. Fuel from the reservoir is being directed through the internal fuel pick-up to the fuel pump. Fuel from the fuel pump may be then directed through the supply line while a portion of the fuel from the fuel pump is being directed to the jet pump and being recirculated from the jet pump to the reservoir, as described previously with reference to FIG. 4. Fuel from the reservoir through the internal fuel pick-up may be supplied to the fuel pump, until the reservoir runs out of fuel. In one example, additional fuel pick-up lines may fluidically connect a location near the front end 560 of the fuel tank to the jet pump, and fuel may be drawn to the reservoir for supplying to the fuel pump. The fuel supply to the engine may be maintained as long as there is fuel available in the reservoir to supply to the fuel pump.

A method 600 for supplying fuel to a FDM inside a fuel tank of a vehicle is illustrated in FIG. 6. In one example, the method 600 may operate the FDM 302 inside the fuel tank illustrated in FIGS. 2 and 3. The FDM 302 may include the fuel pump 351, the jet pump 352, and the fuel pick-up connecting a fuel pick-up location of the fuel tank to the FDM. Instructions for carrying out method 600 and the rest of the methods included herein may be executed by a controller based on instructions stored on a memory of the controller and in conjunction with signals received from sensors of the engine system, such as the fuel level sensor 234 described above with reference to FIG. 1. The controller may employ engine actuators of the engine system to adjust fuel pump operation, according to the methods described below.

At 602, the method 600 includes determining engine operating conditions. For example, method 600 may determine if the engine is propelling a vehicle or if the engine is shut down. The method 600 may also estimate other engine operating parameter including but not limited to, engine speed, engine load, air-fuel ratio, etc. when the engine is combusting. In another example, the method 600 may also receive inputs regarding an existing fuel level in the fuel tank, vehicle speed, battery state of charge (SOC), etc.

The method 600 proceeds to 604 and determines if fuel delivery to the engine is desired. Fuel delivery to the engine for combustion may be desired when the engine is operating and fuel combustion is required for propelling the vehicle A hybrid engine may require fuel, for example, when the state of charge of the battery of the hybrid vehicle is below a threshold charge. If fuel delivery to the engine is desired, the method 600 proceeds to 606, which will be described below. If no fuel delivery to the engine is desired, for example, when the engine is at idle stop or when a hybrid vehicle is operating using the power stored in a battery, the method 600 returns.

At 606, the method includes activating the FDM, for example, through a controller. After activating the FDM, the method 600 proceeds to 608. At 608, the method 600 includes the fuel pump drawing fuel from the reservoir (for example, the reservoir 304 of the FDM 302 illustrated in FIG. 3) through the internal fuel pick-up.

At 610, fuel from the fuel pump is pumped through the supply line to the engine, and a portion of the fuel from the fuel pump is directed to the jet pump for operating the jet pump. Fuel supplied from the fuel pump is high-pressure fuel.

At 612, the method 600 includes the jet pump drawing fuel to the reservoir of the FDM through the fuel pick-up from a fuel pick-up location in the fuel tank. In an example, during 612, the fuel level in the fuel tank may be such that fuel is available along the length of the fuel tank, for example, as illustrated in FIG. 5A. In one example, the fuel pick-up location may be closer to a rear end of the vehicle and farther from the front end of the vehicle. High pressure fuel received by the jet pump from the fuel pump (described at 610), along with the fuel received through the fuel pick-up flows out of the jet pump through the venturi of the jet pump and accumulates in the reservoir housing the fuel pump and the jet pump, as depicted in the schematics in FIGS. 4 and 5A-5C.

In one example at 614, when no fuel is available at the fuel pick-up location for the jet pump to draw to the reservoir, the fuel pump may continue drawing fuel previously collected in the reservoir. In one example at 616, no fuel may be available for the jet pump to draw to the reservoir when the fuel levels in the fuel tank is low (for example less than 5% of fuel tank capacity), and the fuel is accumulated in one location of the fuel tank (all the fuel is accumulated in a location other than the fuel pick-up location) when the vehicle is operating on a gradient (as is illustrated in FIG. 5C). The availability of fuel to the fuel pump from reservoir even when the fuel tank has low fuel level prevents air from being introduced into the fuel pump, while maintaining a supply of fuel to the fuel pump for delivery to the engine. The method 600 then returns.

In this way, the jet pump of the FDM draws fuel through the fuel pick-up to the reservoir. The fuel inside the reservoir supplies fuel to the fuel pump even when no fuel is available at the fuel pick-up location of the fuel tank, maintaining fuel supply to the engine and preventing introduction of air into the fuel pump.

The technical effect of supplying fuel through a dual fuel pick-up system in a fuel tank may include maintaining fuel supply to the engine even when low fuel volume is present inside the fuel tank. Additionally, by providing fuel through the reservoir to the fuel pump, aeration of the fuel and damage to the fuel pump due to low fuel level in the fuel tank may be avoided without installation of check valve/s, reducing the cost and complexity of the fuel delivery system.

An example fuel delivery module includes a fuel pump, a jet pump, a reservoir housing the fuel pump and the jet pump, at least one fuel pick-up configured to fluidically connect a fuel pick-up location of a fuel tank to the jet pump, the jet pump drawing fuel from the fuel pick-up location into the reservoir, and an internal fuel pick-up inside the reservoir configured to fluidically connect the reservoir to the fuel pump. A first example of the fuel delivery module includes wherein the fuel delivery module is configured to be housed in the fuel tank. A second example of the fuel delivery module optionally includes the first example and further includes, wherein the fuel tank is a planar fuel tank. A third example of the fuel delivery module optionally includes one or more of the first and second examples, and further includes wherein the jet pump comprises a motive fluid inlet coupled to an outlet of the fuel pump. A fourth example of the fuel delivery module optionally includes one or more of the first through the third examples, and further includes wherein the jet pump comprises a venturi directing fuel delivered to the jet pump into the reservoir. The fuel delivery module of claim 1, A fifth example of the fuel delivery module optionally includes one or more of the first through the fourth examples, and further includes a base of the reservoir is in apposition with a bottom floor of the fuel tank. A sixth example of the fuel delivery module optionally includes one or more of the first through the fifth examples, and further includes wherein the at least one fuel pick-up is anchored to a bottom floor of the fuel tank.

Another example system includes a fuel delivery module disposed in a fuel tank, the fuel delivery module including a reservoir housing a fuel pump and a jet pump, the fuel pump comprising a fuel pump inlet fluidically connecting the reservoir to the fuel pump, and the jet pump comprises a first jet pump inlet fluidically coupled to the fuel pump for powering the jet pump, a second jet pump inlet fluidically coupled to a fuel pick-up, and a jet pump outlet configured to direct fuel from the jet pump to the reservoir. A first example of the system includes wherein the jet pump outlet comprises a venturi. A second example of the system optionally includes the first example and further includes, wherein the fuel pick-up is configured to fluidically connect a fuel pick-up location of the fuel tank to the jet pump. A third example of the system optionally includes one or more of the first and second examples, and further includes wherein the fuel pick-up location is closer to a rear end of the fuel tank and farther from a front end of the fuel tank. A fourth example of the system optionally includes one or more of the first through the third examples, and further includes wherein the fuel delivery module is closer to the front end of the fuel tank and farther from the rear end of the fuel tank. A fifth example of the system optionally includes one or more of the first through the fourth examples, and further includes wherein the fuel delivery module is at equal distance from the front end and the rear end of the fuel tank.

An example method includes drawing fuel from a fuel pick-up location of a fuel tank through a fuel pick-up line coupled to a jet pump, and directing fuel from the jet pump to a reservoir, the reservoir supplying fuel to a fuel pump for delivering fuel to an engine. A first example of the method includes wherein the reservoir houses the fuel pump and the jet pump. A second example of the method optionally includes the first example and further includes operating the jet pump with fuel supplied through a fuel line from the fuel pump to the jet pump. A third example of the method optionally includes the first through the second examples, and further includes supplying fuel from the reservoir to the fuel pump through an internal fuel pick-up inside the reservoir.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A fuel delivery module, comprising:
a fuel pump;
a jet pump;
a reservoir housing the fuel pump and the jet pump;
at least one fuel pick-up configured to fluidically connect a fuel pick-up location of a fuel tank to the jet pump, the jet pump drawing fuel from the fuel pick-up location into the reservoir; and
an internal fuel pick-up inside the reservoir configured to fluidically connect the reservoir to the fuel pump.

2. The fuel delivery module of claim 1, wherein the fuel delivery module is configured to be housed in the fuel tank.

3. The fuel delivery module of claim 1, wherein the fuel tank is a planar fuel tank.

4. The fuel delivery module of claim 1, wherein the jet pump comprises a motive fluid inlet coupled to an outlet of the fuel pump.

5. The fuel delivery module of claim 1, wherein the jet pump comprises a venturi directing fuel delivered to the jet pump into the reservoir.

6. The fuel delivery module of claim 1, wherein a base of the reservoir is in apposition with a bottom floor of the fuel tank.

7. The fuel delivery module of claim 1, wherein the at least one fuel pick-up is anchored to a bottom floor of the fuel tank.

8. A method, comprising:
drawing fuel from a fuel pick-up location of a fuel tank through a fuel pick-up line coupled to a jet pump; and
directing fuel from the jet pump to a reservoir, the reservoir supplying fuel to a fuel pump for delivering fuel to an engine.

9. The method of claim 8, wherein the reservoir houses the fuel pump and the jet pump.

10. The method of claim 8, further comprising operating the jet pump with fuel supplied through a fuel line from the fuel pump to the jet pump.

11. The method of claim 8, further comprising supplying fuel from the reservoir to the fuel pump through an internal fuel pick-up inside the reservoir.

12. The method of claim 8, further comprising directing fuel through a venturi passage of the jet pump to the reservoir.

13. A fuel delivery system for an engine, comprising:
a fuel delivery module disposed in a fuel tank, the fuel delivery module including a reservoir housing a fuel pump and a jet pump, the fuel pump comprising a fuel pump inlet fluidically connecting the reservoir to the fuel pump; and
the jet pump comprises a first jet pump inlet fluidically coupled to the fuel pump for powering the jet pump, a second jet pump inlet fluidically coupled to a fuel pick-up, and a jet pump outlet configured to direct fuel from the jet pump to the reservoir.

14. The fuel delivery system of claim 13, wherein the jet pump outlet comprises a venturi.

15. The fuel delivery system of claim 13, wherein the fuel pick-up is configured to fluidically connect a fuel pick-up location of the fuel tank to the jet pump.

16. The fuel delivery system of claim 15, wherein the fuel pick-up location is closer to a rear end of the fuel tank and farther from a front end of the fuel tank.

17. The fuel delivery system of claim 16, wherein the fuel delivery module is closer to the front end of the fuel tank and farther from the rear end of the fuel tank.

18. The fuel delivery system of claim 16, wherein the fuel delivery module is at equal distance from the front end and the rear end of the fuel tank.
